(19) United States
(12) Patent Application Publication
(10) Pub. No.: US 2011/0106991 A1
(43) Pub. Date: May 5, 2011

(54) Bus system and bus control method

(75) Inventor: Takayuki KAWAHITO, Kanagawa (JP)

(73) Assignee: Renesas Electronics Corporation, Kawasaki, Kanagawa (JP)

(21) Appl. No.: 12/926,028

(22) Filed: Oct. 21, 2010

(30) Foreign Application Priority Data
Oct. 29, 2009 (JP) 2009-248887

(51) Int. Cl. G06F 13/00

(52) U.S. Cl. 710/110

(57) ABSTRACT

A bus system in accordance with an exemplary aspect of the present invention includes a bus master that performs a preparation for a next access after receiving a write response signal indicating a write result of data in a write access; a bus slave that writes data indicated by a write data signal according to an output of the write data signal from the bus master in the write access, and outputs an authentic write response signal in the writing to the bus master; a bus that connects the bus master and the bus slave, and includes a register slice; and a signal generating unit that outputs a dummy write response signal to the bus master when an end of the write data signal output from the bus master is detected.

### INCORPORATION BY REFERENCE

This application is based upon and claims the benefit of priority from Japanese patent application No. 2009-248887, filed on Oct. 29, 2009, the disclosure of which is incorporated herein in its entirety by reference.

### BACKGROUND

1. Field of the Invention

The present invention relates to a bus system and a bus control method.

2. Description of Related Art

In recent years, a SoC (System On Chip) has a 3DGC (3D Graphics Controller), a multiprocessor CPU (Central Processing Unit), and so on mounted there on. That is, the number of bus masters such as a 3DGC and a CPU mounted on a SoC has increased. Thus, it is a significant challenge to improve a data transfer performance in memory access by these bus masters.

For example, in a unified memory system, memory accesses from multiple bus masters to one memory resource are performed. Thus, it is necessary to improve the data transfer performance indicating the number of bytes of data that the bus master can transfer per second (hereafter referred to as “memory bandwidth”). To improve the data transfer performance, it is necessary to minimize the time wasted in the memory access, and to improve the efficiency of memory access.

By the way, in AXI (Advanced eXtensible Interface) bus standard, data is transferred between a bus master and a bus slave such as an external memory resource. A latch mechanism called a register slice can be inserted between the bus master and the bus slave. The register slice is inserted when a desired operating frequency is not achieved by a transfer of a signal between the bus master and the bus slave. The register slice is an adjusting (delay) circuit. The register slice can be inserted in channels defined by the AXI bus standard. A write address channel, a write data channel, a write response channel, a read address channel, and a read data channel are defined as the channels.

For example, in a SoC adopting the AXI bus standard, when a delay time of the signal transferred between the bus master and the bus slave in a bus is 8 nsec and the operating frequency is 200 MHz (at a cycle of 5 nsec), the delay time is longer than the cycle of the operating frequency. In this case, the delay time of 8 nsec can be divided into intervals of 4 nsec by inserting the register slice between the bus master and the bus slave. This allows the achievement of the desired operating frequency. On the other hand, when the register slice is inserted, there is a disadvantage that one cycle delay occurs due to a latch.

Furthermore, for example, the signal transferred between the bus master and the bus slave includes not only a signal transferred from the bus master to the bus slave as with a signal transferred in the write data channel, but also a signal transferred from bus slave to the bus master as with a signal transferred in the write response channel. Thus, the delay time (hereafter referred to as “latency”) of the signal that is caused by inserting one stage of register slice is two cycle.

In addition, Japanese Unexamined Patent Application Publication No. 2007-140686 discloses a technique capable of performing a dynamic switching operation for switching the operating frequency of a system with a simple configuration at high speed by providing to a register slice means a bypass function for bypassing a latch operation and a decision function for deciding whether the latch operation is bypassed.

### SUMMARY

In AXI bus standard, when the bus master performs a write access to the bus slave, the bus master outputs a write address signal and a write data signal to the bus slave. Then, the bus slave writes data indicated by the write data signal at an address indicated by the write address signal. The bus slave outputs a write complete response signal indicating a result of this writing. The bus master starts preparation for a next write or read access after receiving the write complete response signal output from the bus slave.

Thus, in the case where the register slice of on stage is inserted, when the write access is performed, the signal transferred from the bus master to the bus slave as with the write address signal and the write data signal is delayed for one cycle, and the signal transferred from the bus slave to the bus master as with the write complete response signal is delayed for 1 cycle. That is, a total of 2 cycles of delay occurs. Thus, when the write or read access is performed after the write access is performed, preparation for the write or read access is started with a delay of 2 cycles. That is, a latency of two cycles occurs.

In view of the above, in the case where the one register slice is inserted, when the write or read access is performed after the write access is performed, a latency that occurs the start of the access subsequent to the write access can be expressed by formula (1).

Latency (cycle)=the number of stages of the register slice×2 (cycles)+the number of cycles (cycles) after the bus master receives the write complete response signal before the next access is ready (1)

For example, if the number of stages of the register slice is three and the number of cycles after the bus master receives the write complete response signal before the next access is ready is five, a latency of (3×2+5=) 11 cycles occurs. In addition, the latency increases every two cycles for every time the number of stages of the register slice increases one by one.

As explained above, when the write access is performed, the bus master starts preparation for the next write or read access after receiving the write complete response signal, which has been delayed by the register slice, from the bus slave. Thus, there is a problem that the data transfer performance degrades.

On the other hand, the technique disclosed in Japanese Unexamined Patent Application Publication No. 2007-140686 can improve the latency by bypassing the register slice, when the operating frequency of the system is changed to a low frequency. However, when the operating frequency of the system is changed to a high frequency, the register slice cannot be bypassed. Thus, in this case, the latency does not improve. Consequently, the problem as mentioned above is still unsolved. Furthermore, even if the operating frequency of the system is changed to a low frequency, the same problem occurs when all of the register slices are not bypassed.

A first exemplary aspect of the present invention is a bus system including: a bus master that performs a preparation for a next access after receiving a write response signal indicating a write result of data in a write access; a bus slave that writes data indicated by a write data signal according to an output of the write data signal from the bus master in the write access, and outputs an authentic write response signal in the writing to the bus master; a bus that connects the bus master and the bus slave, and includes a register slice; and a signal generating unit that outputs a dummy write response signal to the bus master, when an end of the write data signal output from the bus master is detected.

A second exemplary aspect of the present invention is a bus control method for a bus that connects a bus master and a bus slave, and includes a register slice, the bus master being configured to perform a preparation for a next access after receiving a write response signal indicating a write result of data in a write access, the bus slave being configured to write data indicated by a write data signal according to an output of the write data signal from the bus master in the write access, and to output an authentic write response signal in the writing to the bus master, the bus control method including; detecting an end of the write data signal output from the bus master; and outputting a dummy write response signal to the bus master.

According to exemplary aspects of the present invention, it is possible to start preparation for the next access in response to the input of the dummy write response signal before receiving the authentic write response signal in the bus master. Thus, the writing in the bus slave and the preparation for the next access in the bus master can be performed in parallel. Consequently, the latency that occurs when the write or read access is performed after the write access is performed can be reduced. That is, when the write access is performed, the data transfer performance can be improved.

According to the above-mentioned exemplary aspects of the present invention, it is possible to provide a bus system and a bus control method that are capable of improving a data transfer performance when a write access is performed.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a configuration diagram of a bus system according to a first exemplary embodiment of the present invention;

FIG. 2 is a diagram showing a detailed connection relationship among a bus master, a write response control unit, and a register slice according to the first exemplary embodiment of the present invention;

FIG. 3 is a state transition diagram of the signal generating unit according to the first exemplary embodiment of the present invention;

FIG. 4 is an operation timing diagram of a signal generating unit according to the first exemplary embodiment of the present invention;

FIG. 5 is an operation timing diagram of a write response control unit in the case where the sequence of a read access and a write access is reversed;

FIG. 6 is a mask operation timing diagram of a valid signal and a ready signal of the write response control unit according to the first exemplary embodiment of the present invention;

FIG. 7 is a configuration diagram of a bus system according to a second exemplary embodiment of the present invention;

FIG. 8 is a diagram showing a detailed connection relationship among a bus master, a write response control unit, and a register slice according to the second exemplary embodiment of the present invention; and

FIG. 9 is an operation timing diagram of a signal generating unit according to the second exemplary embodiment of the present invention.

### DETAILED DESCRIPTION OF THE EXEMPLARY EMBODIMENTS

### First Exemplary Embodiment

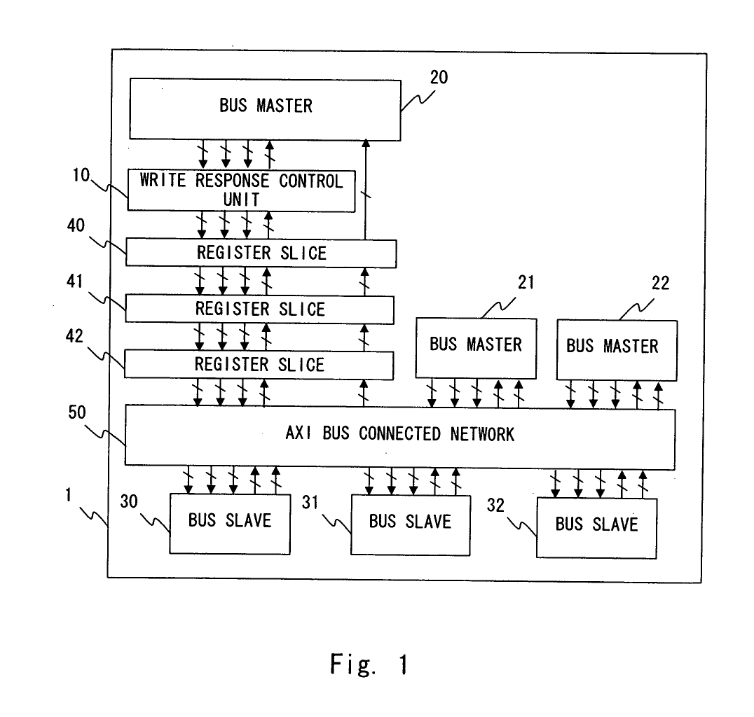

A configuration of a bus system 1 in accordance with a first exemplary embodiment of the present invention is explained with reference to FIG. 1. FIG. 1 is a configuration diagram of the bus system 1 according to the first exemplary embodiment of the present invention.

The bus system 1 includes a write response control unit 10, bus masters 20, 21, and 22, bus slaves 30, 31, and 32, register slices 40, 41, and 42, and an AXI bus connected network 50.

First, a connection relationship among the composition elements included in the bus system 1 described above is explained.

Note that, in AXI bus standard, five channels including a write address channel, a write data channel, a write response channel, a read address channel, and a read data channel are defined. Each of the channels includes a signal network transmitting three signals including a data signal (in the write address channel and the read address channel, an address signal), a valid signal, and a ready signal.

The bus masters 20-22 and the bus slaves 30-32 are connected to each other via the AXI bus connected network 50. That is, a bus connecting the bus masters 20-22 and the bus slaves 30-32 includes the five channels and the AXI bus connected network 50. Three channels including the write address channel, the write data channel, and the read address channel transmit data and an address from the bus masters 20-22 to the bus slaves 30-32. Two channels including the write response channel and the read data channel transmit a response and data from the bus slaves 30-32 to the bus masters 20-22.

The register slices 40-42 are connected between the bus master 20 and the AXI bus connected network 50. The write response control unit 10 is connected between the bus master 20 and the register slice 40 closest to the bus master 20. Note that the bus master 20 is directly connected to the write response control unit 10 by four channels including the write address channel, the write data channel, the write response channel, and the read address channel, and is directly connected to the register slice 40 by the read data channel.

The bus masters 20-22 write data to and read data from the bus slaves 30-32. For example, the bus masters 20-22 are a CPU, a DMA (Direct Memory Access) controller, and so on.

For example, the bus slaves 30-32 are a memory, a register, and so on.

Each of the register slices 40-42 is an adjusting (delay) inserted circuit to prevent a delay time of the bus from exceeding the cycle of the operating frequency. The register slices 40-42 each include a latch mechanism. The register slices 40-42 transmit signals between the bus master 20 and the bus slaves 30-32 by passing or holding the signal input via each of the channels.

The AXI bus connected network 50 adjusts an access sequence of bus accesses such as the write access and the read access that are issued from the bus masters 20-22 to the bus slaves 30-32.

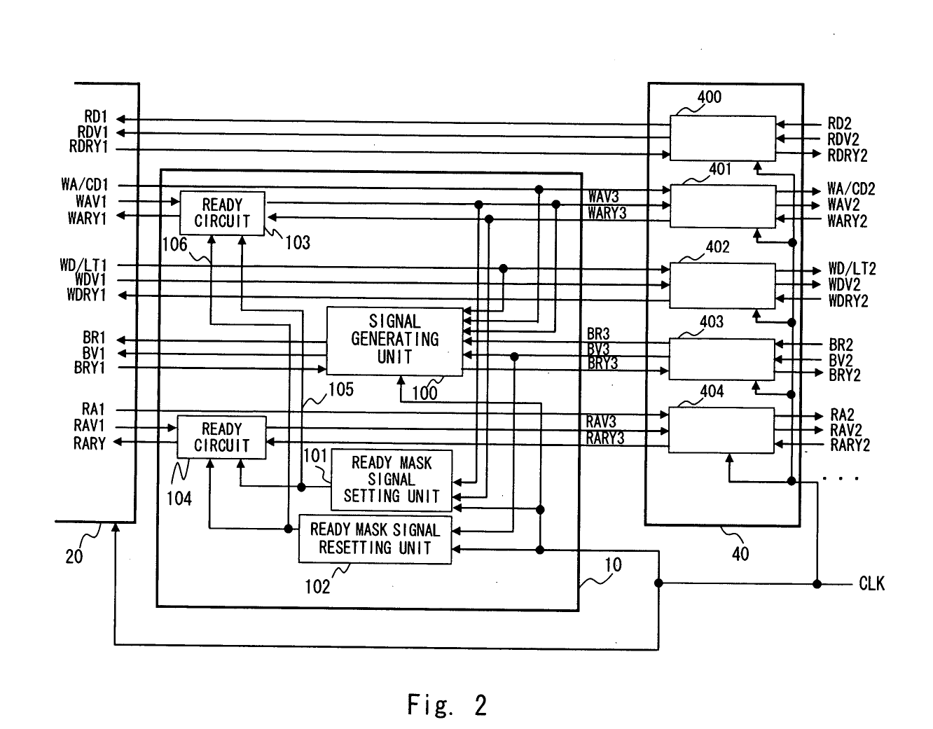

Note that, as described above, each of the five channels in the AXI bus standard transmits the three signals including the data signal (or the address signal), the valid signal, and the ready signal. In addition, signal names described below correspond to signal names shown in FIG. 2 described later.

Specifically, the write address channel transmits write address signals WA/CD1, and WA/CD2, write address valid signals WAV1, WAV2, and WAV3, and write address ready signals WARY1, WARY2, and WARY3. The write data channel transmits write data signals WD/LT1, and WD/LT2, write data valid signals WDV1, and WDV2, and write data ready signals WDRY1, and WDRY2. The write response channel transmits write complete response signals BR1, BR2, and BR3, write complete response valid signals BV1, BV2, and BV3, and write complete response ready signals BRY1, BRY2, and BRY3.

The read address channel transmits read address signals RA1, and RA2, read address valid signals RAV1, RAV2, and RAV3, and read address ready signals RARY1, RARY2, and RARY3. The read data channel transmits read data signals RD1, and RD2, read data valid signals RDV1, and RDV2, and read data ready signals RDRY1, and RDRY2.

The valid signal indicates whether a valid data signal (or address signal) is output. That is, the valid signal is a signal indicating whether the data signal (or the address signal) validly exists. The ready signal indicates whether the data signal (or the address signal) can be obtained. When the valid signal indicates that the data signal (or the address signal) validly exists and the ready signal indicates that the data signal (or the address signal) can be obtained, a handshake between a sending side of the valid signal and a receiving side of the ready signal is complete. When the handshake is complete, the sending side obtains the data signal (or the address signal). In other words, when the handshake is complete, the data signal is validly transmitted from the sending side to the receiving side.

Next, a configuration of the write response control unit 10 in accordance with the first exemplary embodiment of the present invention is explained with reference to FIG. 2. FIG. 2 is a diagram showing a detailed connection relationship among the bus master 20, the write response control unit 10, and the register slice 40 according to the first exemplary embodiment of the present invention.

The write response control unit 10 includes a signal generating unit 100, a ready mask signal setting unit 101, a ready mask signal resetting unit 102, and ready circuits 103, and 104. The register slice 40 includes sub register slices 400, 401, 402, 403, and 404.

The signal generating unit 100 outputs a dummy write response signal to the bus master 20, when the signal generating unit 100 detects the end of the write data signal WD/LT1 output from the bus master 20. The write complete response signal BR1 and the write complete response valid signal BV1 correspond to the write response signal.

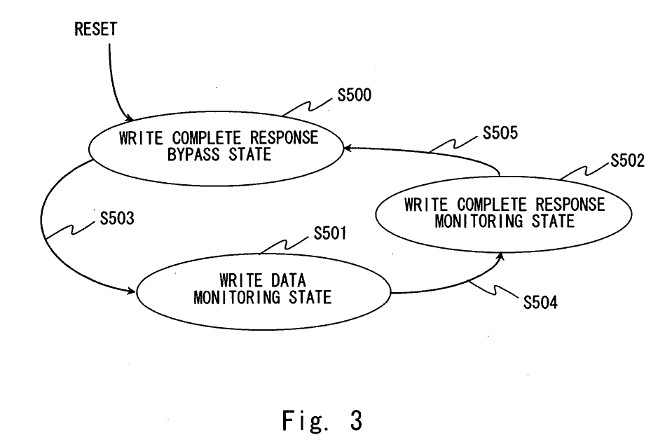

The state transition of the signal generating unit 100 is explained with reference to FIG. 3. FIG. 3 is a state transition diagram of the signal generating unit according to the first exemplary embodiment of the present invention.

First, the signal generating unit 100 transits to a write complete response bypass state (S500) after resetting the bus master 20 and the register slice 40. In the write complete response bypass state, the signal generating unit 100 directly outputs the write complete response signal BR3 and the write complete response valid signal BV3 that are output from the sub register slice 403 as the write complete response signal BR1 and the write complete response valid signal BV1 to the bus master 20. Furthermore, the signal generating unit 100 directly outputs the write response ready complete signal BRY1 output from the bus master 20 as the write complete response ready signal BRY3 to the sub register slice 403.

When a valid write address signal WA/CD1 with an uncached attribute is output from the bus master 20, the signal generating unit 100 transits to a write data monitoring state (S501).

In the write data monitoring state, the signal generating unit 100 monitors whether a last write data signal WD/LT1 is output from the bus master 20 to the sub register slice 402.

When the last write data signal WD/LT1 is output from the bus master 20 to the sub register slice 402, the signal generating unit 100 transits to a write complete response monitoring state (S502) (S504). In the write complete response monitoring state, the signal generating unit 100 speculatively outputs the dummy write response signal BR1 and write complete response valid signal BV1.

Note that, in the AXI bus standard, writing with a cache attribute and a writing with an uncached attribute are defined. When the bus master 20 performs the writing with an uncached attribute among these writings, the bus master 20 waits for the write complete response signal BR1 indicating a result of writing in the bus slaves 30-32. When the writing with the uncached attribute is performed by the bus master 20, the signal generating unit 100 transits to the write data monitoring state (S503). Then, the signal generating unit 100 speculatively outputs the dummy write response signal BR1 and write complete response valid signal BV1, when the last write data signal WD/LT1 is output from the bus master 20.

In this way, a sequence of the write accesses defined in the AXI bus standard is completed in the bus master 20, when the signal generating unit 100 speculatively outputs the dummy write complete response signal BR1 and write complete response valid signal BV1 to the bus master 20. As a result, the bus master 20 can start preparation for the next write or read access without waiting for the authentic write complete response signal BR3 and write complete response valid signal BV3 that are output from the bus slaves 30-32 via the sub register slice 403.

Furthermore, the signal generating unit 100 starts to mask the authentic write complete response signal BR3 and write complete response valid signal BV3 that are output from the sub register slice 403. The signal generating unit 100 prevents the valid write complete signal BR1 and write complete response valid signal BV1 from being redundantly output to the bus master 20 by masking the authentic write complete response signal BR3 and write complete response valid signal BV3. Note that, Owing to the structure adopting the AXI bus standard, the bus master 20 may be configured not to obtain the write complete response signal BR1, and thus only the write complete response valid signal BV3 may be masked.

Furthermore, the signal generating unit 100 starts to mask the write complete response ready signal BRY1 output from the bus master 20, and starts to output the dummy write complete response ready signal BRY3 to the sub register slice 403.

Note that, when the bus master 20 receives the dummy write complete response signal BR1 and write complete response valid signal BV1 from the signal generating unit 100, there is a possibility that the bus master 20 is outputting an invalid write complete response ready signal BRY1. For this reason, the signal generating unit 100 outputs a valid dummy write complete response ready signal BRY3. This enables the handshake to be completed, when the authentic write complete response signal BR3 and write complete response valid signal BV3 are output from the sub register slice 403.

Then, the signal generating unit 100 waits for the authentic write complete response signal BR3 and write complete response valid signal BV3 to be output from the bus slaves 30-32.

When the signal generating unit 100 receives the authentic write complete response signal BR3 and write complete response valid signal BV3, which output from the bus slaves 30-32, from the sub register slice 403, the signal generating unit 100 transits to the write complete response bypass state (S500) (S505). At this time, the signal generating unit 100 cancels the masking of the write complete response signal BR3 and the write complete response valid signal BV3. Furthermore, the signal generating unit 100 cancels the masking of the write complete response ready signal BRY1, and stops outputting the dummy write complete response ready signal BRY3.

When the ready mask signal setting unit 101 detects the completion of a handshake between the bus master 20 and the sub register slice 401 in the write address channel, the ready mask signal setting unit 101 outputs a ready mask request signal 105 to the ready circuits 103, and 104. The ready mask request signal 105 is a signal that instructs to mask a signal.

Note that, in the AXI bus standard, a sequence of processing in the writing or reading is performed with the output of the write address signal WA/CD1 or the read address signal RA1 from the bus master 20 as a trigger. Therefore, in this exemplary embodiment, the write access is a sequence of processing from the valid transmission of the address signal WA/CD1 from the bus master 20 after the completion of the handshake between the bus master 20 and the register slice 40 in the address channel, until the outputting of the valid write complete response signal BR1 to the bus master 20. That is, when the ready mask signal setting unit 101 detects the completion of the handshake for starting the write access, the ready mask signal setting unit 101 outputs the ready mask request signal 105 to the ready circuits 103 and 104. Note that this completion of the handshake is detected based on the write address valid signal WAV3 and the write address ready signal WARY3.

When the ready mask signal resetting unit 102 detects that the valid write complete response signal BR 3 is output from the bus slaves 30-32 to the bus master 20, the ready mask signal resetting unit 102 outputs a ready mask cancel signal 106 to the ready circuit 103, 104. The ready mask cancel signal 106 is a signal that instructs to cancel the masking of the signal. Note that the valid write complete response signal BR3 is detected based on the write response valid signal BV3.

The ready circuit 103 masks the write address valid signal WAV1 and the write address ready signal WARY3 in response to the input of the ready mask request signal 105 from the ready mask signal setting unit 101. Furthermore, the ready circuit 103 cancels the masking of the write address valid signal WAV1 and the write address ready signal WARY3 in response to the input of the ready mask cancel signal 106 from the ready mask signal resetting unit 102. When the ready circuit 103 cancels the masking, the ready circuit 103 outputs the write address valid signal WAV1 as the write address valid signal WAV3, and outputs the write address ready signal WARY3 as the write address ready signal WARY1.

The ready circuit 104 masks the read address valid signal RAV1 and the read address ready signal RARY3 in response to the input of the ready mask request signal 105 from the ready mask signal setting unit 101. Furthermore, the ready circuit 104 cancels the masking of the read address valid signal RAV1 and the read address ready signal RARY3 in response to the input of the ready mask cancel signal 106 from the ready mask signal resetting unit 102. When the ready circuit 104 cancels the masking, the ready circuit 104 outputs the read address valid signal RAV1 as the read address valid signal RAV3, and outputs the read address ready signal RARY3 as the read address ready signal RARY1.

The signal generating unit 100, the ready mask signal setting unit 101, the ready mask signal resetting unit 102, the ready circuits 103, and 104, and the sub register slices 400, 401, 402, and 403 operate by being supplied with a clock signal CLK.

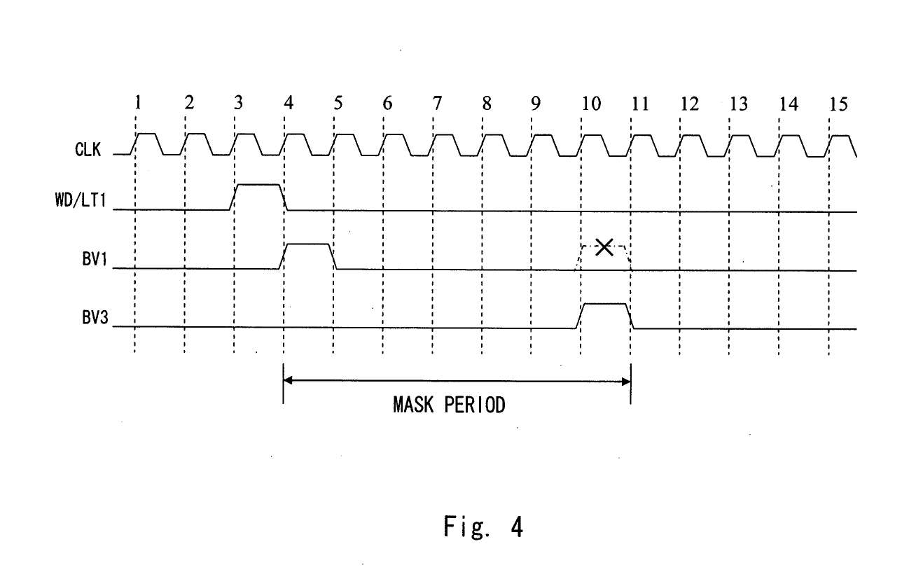

Next, an operation of the bus system 1 according to the first exemplary embodiment of the present invention is explained with reference to FIGS. 4-6.

First, an operation of the signal generating unit 100 is explained with reference to FIG. 4. FIG. 4 is an operation timing diagram of the signal generating unit 100 according to the first exemplary embodiment of the present invention.

First, in the write complete response bypass state (S500), the signal generating unit 100 transits to the write data monitoring state (S501), when the valid write address signal WA/CD1 with an uncached attribute is output from the bus master 20. Note that the signal generating unit 100 evaluates whether the writing belongs to the uncached attribute by referring to the write address signal WA/CD1 output from the bus master 20. Furthermore, the signal generating unit 100 evaluates whether the write address signal WA/CD1 is valid by referring to the write address valid signal WAV3 output from the ready circuit 103.

When the signal generating unit 100 receives the last write data signal WD/LT1 output from the bus master 20 at cycle 3 after transiting to the write data monitoring state (S501), the signal generating unit 100 speculatively outputs the dummy write complete response signal BR1 and the write complete response valid signal BV1 to the bus master 20 at the next cycle 4. Note that, in the explanation of the operation of this exemplary embodiment, the phrase “output the valid signal” or “output the ready signal”, used herein means that a valid “1” valid signal or ready signal is output. Note that the signal generating unit 100 evaluates whether the write data signal WD/LT1 is the last by referring to the write data signal WD/LT1 output from the bus master 20.

At cycle 4, the signal generating unit 100 starts to mask the write complete response signal BR3 and the write complete response valid signal BV3 that are output from the sub register slice 403. This prevents the signal generating unit 100 from transmitting the authentic the write complete response signal BR3 (not shown) and write complete response valid signal BV3 the bus master 20 by masking these signals, upon receiving the authentic write complete response signal BR3 and write complete response valid signal BV3 that are output from the bus slaves 30-32 via the register slice 403 at cycle 10. In this way, the signal generating unit 100 prevents the valid “1” write complete response signal BR1 and the write complete response valid signal BV1 from being redundantly output to the bus master 20 by masking the write complete response signal BR3 and the write complete response valid signal BV3 from cycle 4 to cycle 10.

Furthermore, at cycle 4, the signal generating unit 100 starts to mask the write complete response ready signal BRY1 (not shown) output from the bus master 20, and starts to output the dummy write complete response ready signal BRY3 (not shown) to the sub register slice 403. In this way, the signal generating unit 100 masks the write complete response ready signal BRY1 and outputs the dummy write complete response ready signal BRY3 from cycle 4 to cycle 10. This enables the sub register slice 403 to recognize the completion of the handshake, when the authentic write complete response signal BR3 and the write complete response valid signal BV3 are output at cycle 10.

When the authentic write complete response signal BR3 and the write complete response valid signal BV3 are input to the signal generating unit 100 at cycle 10, there is no possibility that the authentic write complete response signal BR3 and the write complete response valid signal BV3 are output to the bus master 20 from then on. Thus, at cycle 11, the signal generating unit 100 cancels the masking of the authentic write complete response signal BR3 and the write complete response valid signal BV3. Furthermore, at cycle 11, the signal generating unit 100 cancels the masking of the write complete response ready signal BRY1, and stop outputting the dummy write complete response ready signal BRY3.

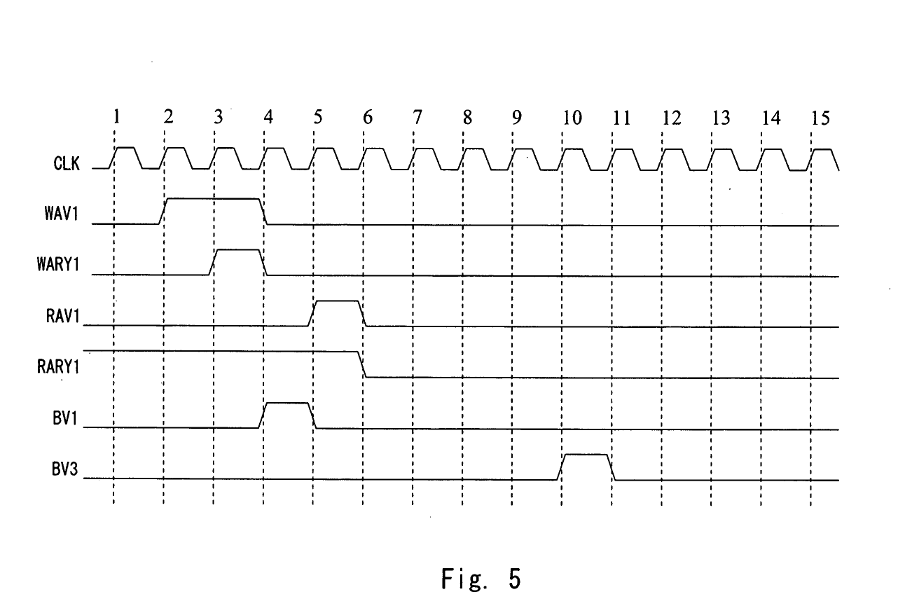

Next, an example of a case that a mask operation of the valid signal and the ready signal is necessary is explained before explaining the mask operation of the valid signal and the ready signal in the write response control unit 10. FIG. 5 is an operation timing diagram of a write response control unit in case that a sequence of the read access and the write access is reversed.

FIG. 5 shows a case that the signal generating unit 100 receives the last write data signal WD/LT1 output from the bus master 20 at cycle 3 after the signal generating unit 100 has transited to the write data monitoring state. At cycle 4, the signal generating unit 100 speculatively outputs the dummy write complete response signal BR1 and the write complete response valid signal BV1 to the bus master 20. However, the completion of the writing of data in the bus slaves 30-32 is not assured until the authentic write complete response signal BR3 and the write complete response valid signal BV3 are output from the bus slaves 30-32 at cycle 10.

At cycle 4, the bus master 20 receives the dummy write complete response signal BR3 and the write complete response valid signal BV3 that are output from the signal generating unit 100 in response to the last write data signal WD/LT1 (not shown). Then, the bus master 20 immediately starts preparation for the next write or read access. Note that FIG. 5 shows a case that the bus master 20 starts to read data at cycle 5 from the same address as the address at which data is written by the write data signal WD/LT1 output from the bus master 20 at cycle 3.

At cycle 5, the bus master 20 outputs the read address signal RA1 (not shown) and the read address valid signal RAV1 to the sub register slice 404. Assume herein that the sub register slice 404 outputs the read address ready signal RARY3 to the bus master 20 at cycle 5. As this time, the handshake is complete, if the ready circuit 104 does not mask the read address valid signal RAV1 and the read address ready signal RARY3. Thus, the register slice 40 transmits the read address signal RA1 to the AXI bus connected network 50.

However, the read access may be made to the bus slaves 30-32 before the write access depending on a condition of adjustment of the AXI bus connected network 50. That is, the read address signal RA2 and the read valid signal RAV2 may be output from the AXI bus connected network 50 to the bus slaves 30-32 before the last write data signal WD/LT2 and the write data valid signal WDV2.

In this case, the read access overtakes the write access. Thus, the bus master 20 expects to read written data, but data before the writing is performed is read. Thus, there is a possibility that an inconsistency occurs in the data used by the bus master 20 and an error occurs in the processing of the bus system 1.

Consequently, in this first exemplary embodiment, the ready circuits 103 and 104 mask the valid signal and the ready signal until the authentic write complete response signal BR3 is output from the bus slaves 30-32 and the completion of the writing of data is assured after the completion of the handshake for starting the write access. This inhibits the handshake for starting the next access, and prevents the sequence of accesses from being reversed.

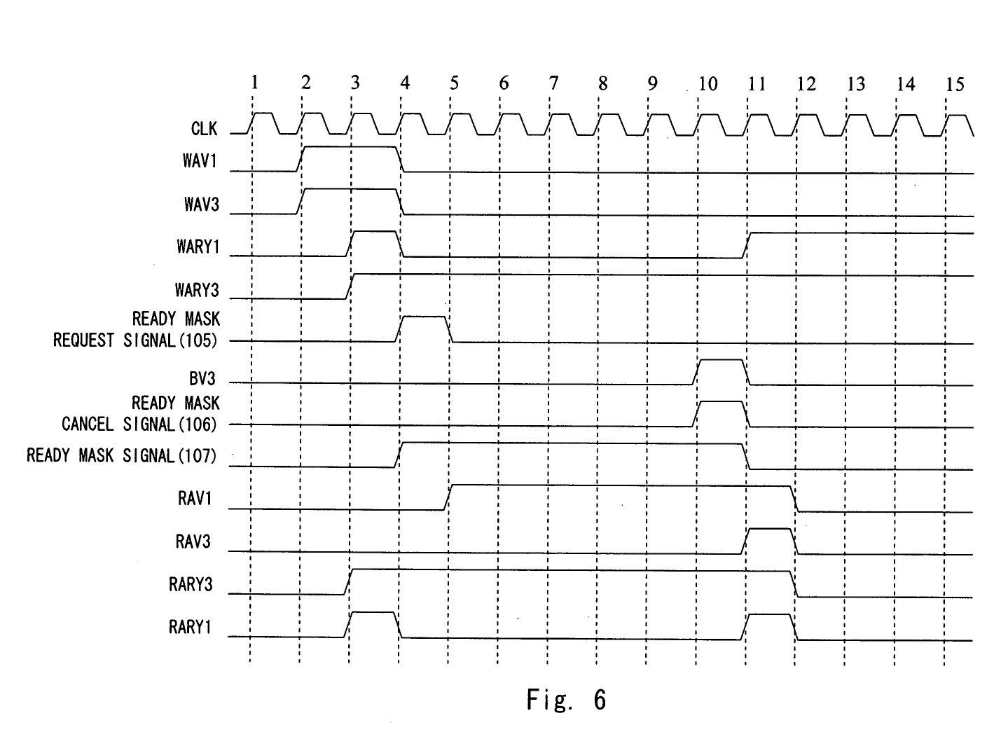

Next, a mask operation of the valid signal and the ready signal in the write response control unit 10 in accordance with the first exemplary embodiment of the present invention is explained with reference to FIG. 6. Note that FIG. 6 is an operation timing diagram of the write response control unit 10 when the bus master 20 performs the same operation as the operation explained with reference to FIG. 4.

At cycle 3, both the write address valid signal WAV1 output from the bus master 20 and the write address ready signal WARY3 output from the sub register slice 401 become valid “1”. Thus, the handshake in the write address channel is complete. Then, the write address signal WA/CD1 is validly transmitted from the bus master 20 to the sub register slice 401.

In this way, when the write address valid signal WAV1 and the write address ready signal WARY3 become valid “1”, the ready signal setting unit 101 asserts the ready mask request signal 105 as “1”, and outputs the ready mask request signal 105 to the ready circuits 103 and 104 at the next cycle 4.

When the ready circuits 103 and 104 receives the ready mask request signal 105, which has been asserted as “1”, from the ready mask signal setting unit 101 at cycle 4, each of the ready circuits 103 and 104 generates the ready mask signal 107 asserted as “1” and outputs the ready mask signal 107 in each of the ready circuits 103 and 104.

The ready circuit 103 masks the write address valid signal WAV1 and the write address ready signal WARY3 while the ready mask signal 107 asserted as “1” is output in the ready circuit 103. That is, the ready circuit 103 outputs the write address valid signal WAV3 and the write address ready signal WARY1 that are negated as “0” while the ready mask signal 107 is output in the ready circuit 103.

The ready circuit 104 masks the read address valid signal RAV1 and the read address ready signal RARY3 while the ready mask signal 107 is output in the ready circuit 104. That is, the ready circuit 104 outputs the read address valid signal RAV3 and the read address ready signal RARY1 that are negated as “0” while the ready mask signal 107 is output in the ready circuit 104.

While the bus master 20 makes the read address valid signal RAV1 valid as “1” at cycle 5, the read address ready signal RARY1 input to the bus master 20 is invalid as “0”. Thus, the bus master 20 decides that the handshake with the sub register slice 404 is not complete. In the same way, even if the sub register slice 404 makes the read address ready signal RARY3 valid as “1”, the read address valid signal RAV3 input to the sub register slice 404 is invalid as “0”. Thus, the sub register slice 404 decides that the handshake with the bus master 20 is not complete.

In this way, the read access from the bus master 20 to the bus slaves 30-32 is masked at the write response control unit 10 in front of the register slice 40 by the ready circuit 104.

At cycle 10, the valid write complete response valid signal BV3 as “1” is input to the signal generating unit 100. Consequently, at cycle 10, the completion of the writing of data in the bus slaves 30-32 is assured. Thus, when the valid write complete response valid signal BV3 as “1” is input to the ready mask signal resetting unit 102, the ready mask signal resetting unit 102 asserts the ready mask cancel signal 106 as “1”, and outputs the ready mask cancel signal 106 to the ready circuits 103 and 104.

When the ready circuits 103, and 104 receive the ready mask cancel signal 106 asserted as “1” at cycle 10, each of the ready circuits 103 and 104 negates the ready mask signal 107 as “0” in each of the ready circuits 103 and 104.

When the ready mask signal 107 negated as “0” is output in the ready circuit 103 at cycle 11, the ready circuit 103 cancels the masking of the write address valid signal WAV1 and the write address ready signal WARY3. As a result, the ready circuit 103 outputs the write address valid signal WAV1 input from the bus master 20 as the write address valid signal WAV3. Furthermore, the ready circuit 103 outputs the write address ready signal WARY3 input from the sub register slice 401 as the write address ready signal WARY1.

When the ready mask signal 107 negated as “0” is output in the ready circuit 104 at cycle 11, the ready circuit 104 cancels the masking of the read address valid signal RAV1 and the read address ready signal RARY3. As a result, the ready circuit 104 outputs the read address valid signal RAV1 input from the bus master 20 as the read address valid signal RAV3. Furthermore, the ready circuit 104 outputs the read address ready signal RARY3 input from the sub register slice 404 as the read address ready signal RARY1.

As a result, at cycle 11, the read address valid signal RAV3 and the read address ready signal RARY1 are asserted as “1”. Thus, the handshake between the bus master 20 and the register slice 40 is complete. Consequently, the read access to the bus slaves 30-32 is started.

Note that, at cycle 10, the write complete response valid signal BV3 output from the sub register slice 403 indicates that the write complete response signal BR3 notifying a completion result of the writing in the bus slaves 30-32 is validly output. Accordingly, at cycle 10, the completion of the writing in the bus slaves 30-32 is assured. Thus, in the first exemplary embodiment, the signals are masked in the ready circuits 103, and 104 until cycle 10, and the write or read access is made after cycle 11. This enables the sequence of accesses to be maintained, while preventing the access sequence from being reversed.

Next, the data transfer performance of the bus system 1 of this first exemplary embodiment as described above is explained with reference to formulas. Note that X1 indicates the number of stages of the register slice, and Y1 indicates the number of cycles after the bus master receives the write complete response signal before the next access is ready. Each of Z1 and Z2 indicates a latency that occurs until the start of the next access, when the write or read access is performed after the write access is performed (hereafter referred to as “sequence access”).

First, the latency Z1 (cycle) of the related art explained as formula (1) is shown as formula (2).

Z1=X1×2+Y1 (2)

In the related art, the latency Z1 of the sequence access is a sum of twice the number of stages of the register slice X1 and the latency Y1 by the preparation of access of the bus master. As described above, the reason for doubling the number of stages of the register slice X1 is that the signal output to the write data channel is delayed for one cycle and the signal output to the write response channel is delayed one cycle by the register slice of one stage. That is, a total of two cycles of delay occurs. Note that Y1 is dependent on the number of logical stages and the operating frequency of the bus master.

Next, when X1×2>=Y1, the latency Z2 (cycle) of the first exemplary embodiment is shown as formula (3).

Z2=X1×2 (3)

In this way, when X1×2>=Y1, the latency Z2 that occurs in the register slice is only “X1×2”.

The reason for this is explained with reference to a specific example. For example, in FIG. 4 and FIG. 6, the last write data signal WD/LT1 is output at cycle 3. In this first exemplary embodiment, the number of stages of the register slices is 3. Thus, “X1×2” is “3×2=6”. That is, the authentic write complete response valid signal BV3, which should return at cycle 4 if no register slice is provided, is delayed for six cycles and returns at cycle 10. Consequently, at cycle 11, the masking is cancelled in the ready circuits 103, and 104, and the next access becomes possible.

Note that, the case where Y1 is 6, i.e., X1×2=Y1, is explained. In this case, it takes six cycles to prepare for the next access. That is, after the reception of the dummy write complete response valid signal BV1 at cycle 4, preparation for the next access is made during cycles 5-10. Consequently, at cycle 11, the bus master 200 is ready to perform the next access. In this case, at cycle 11, the masking in the ready circuits 103 and 104 is cancelled, and thus the next access is performed.

Next, the case where Y1 is 5, i.e., X1×2>Y1, is explained. In this case, it takes five cycles to prepare for the next access. That is, at cycle 4, after the reception of the dummy write complete response valid signal BV1 at cycle 4, preparation for the next access is made during cycles 5-9. Consequently, at cycle 10, the bus master 20 is ready to perform the next access. However, at cycle 10, the masking in the ready circuits 103, and 104 are not cancelled. Thus, in the result, the next access is performed at cycle 11 when the masking is cancelled.

That is, when X1×2>Y1, the next access is delayed for “3×2=6” cycles, and the next access is performed at cycle 11. Thus, the latency Z2 is only “X1×2”.

Now, the latency of the sequence access in the related art is compared with that in the first exemplary embodiment. Herein, of the case where X1=3 and Y1=5 is explained.

The latency of the sequence access in the related art is expressed as Z1=3×2+5=11 cycles based on formula (2).

The latency of the sequence access in this first exemplary embodiment is expressed as Z2=3×2=6 cycles based on formula (3). Consequently, the data transfer performance of this first exemplary embodiment is improved by five cycles compared with the related art.

On the other hand, in the case of X1×2<Y1, the latency Z2 (cycle) of this first exemplary embodiment is shown as formula (4).

Z2=Y1 (4)

In this way, when X1×2<Y1, the latency Z2 is only “Y1” caused by the preparation of the next access in the bus master.

The reason for this is explained with specific example. For example, in FIG. 4 and FIG. 6, the last write data signal WD/LT1 is output at cycle 3. In the first exemplary embodiment, the number of stages of the register slice is three. Thus, “X1×2” is “3×2=6”. That is, the authentic write complete response valid signal BV3, which should return at cycle 4 if no register slice is provided, is delayed for six cycles, and returns at cycle 10. Consequently, at cycle 11, the masking is cancelled in the ready circuits 103, and 104, and the next access becomes possible.

Note that, the case where Y1 is 7, i.e., X1×2<Y1, is explained. In this case, it takes seven cycles to prepare for the next access. That is, after the reception of the dummy write complete response valid signal BV1 at cycle 4, preparation for the next access is made during cycle 5-11. Consequently, at cycle 12, the bus master 20 is ready to perform the next access. In this case, the masking in the ready circuits 103 and 104 is already cancelled at cycle 11. However, the next access is ready in the bus master 20 at cycle 12. Thus, at cycle 12, the next access is performed. Consequently, when X1×2<Y1, the latency Z2 is only “Y1”.

Now, the latency of the sequence access in the related art is compared with that in the first exemplary embodiment. Herein, of the case when X1=3 and Y1=8 is explained.

The latency of the sequence access in the related art is expressed as Z1=3×2+8=14 cycles based on formula (2).

The latency of the sequence access in this first exemplary embodiment is expressed as Z2=8 cycles based on formula (2). Consequently, the data transfer performance of this first exemplary embodiment is improved by six cycles compared with the related art.

As explained with reference to formulas (2)-(4), this first exemplary embodiment can minimize the latency, even when the number of stages of the register slice increases. Thus, the latency of the sequence access from the bus master can be reduced, thus an access adapted for the operating frequency of the SoC can be made.

As described above, in this first exemplary embodiment, the dummy write response signal is speculatively output to the bus master, when the bus master outputs the write data signal. This enable the bus master to start preparation for the next access in response to the input of the dummy write response signal before receiving the authentic write response signal. Thus, the writing in the bus slave and the preparation of the next access in the bus master can be performed in parallel. Consequently, the latency caused when the write or read access is performed after the write access is performed can be reduced. That is, when the write access is performed, the data transfer performance can be improved.

### Second Exemplary Embodiment

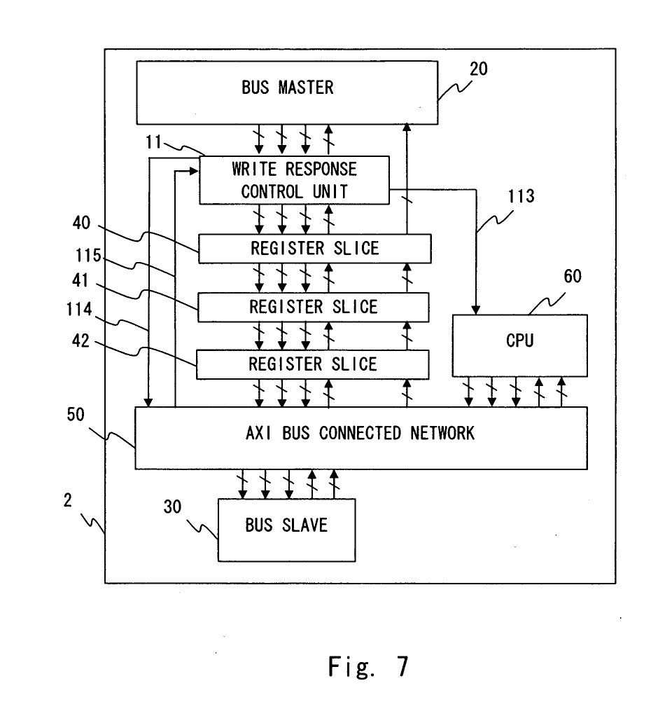

A configuration of a bus system 2 in accordance with a second exemplary embodiment of the present invention is explained with reference to FIG. 7. FIG. 7 is a configuration diagram of the bus system 2 according to the second exemplary embodiment of the present invention.

The bus system 2 of the second exemplary embodiment differs from the bus system 1 of the first exemplary embodiment in the following points. That is, the bus system 2 includes a write response signal unit 11 in place of the write response signal unit 10. Furthermore, the bus system 2 further includes a CPU 60. Note that, in FIG. 7, the bus masters 21, and 22 and the bus slaves 31, and 32 are omitted.

The write response control unit 11 outputs an error notification signal 113 to the CPU 60. The error notification signal 113 is an interrupt notification signal notifying that an error has been detected. Furthermore, the write response control unit 11 outputs an ID/address information signal 114 to the CPU 60 via the AXI bus connected network 50. The ID/address information signal 114 includes ID/address information.

The CPU 60 outputs a data output request signal 115 to the write response control unit 11 via the AXI bus connected network 50 in response to an input of the error notification signal 113 output from the write response control unit 11. The data output request signal 115 is a signal requesting the ID/address information.

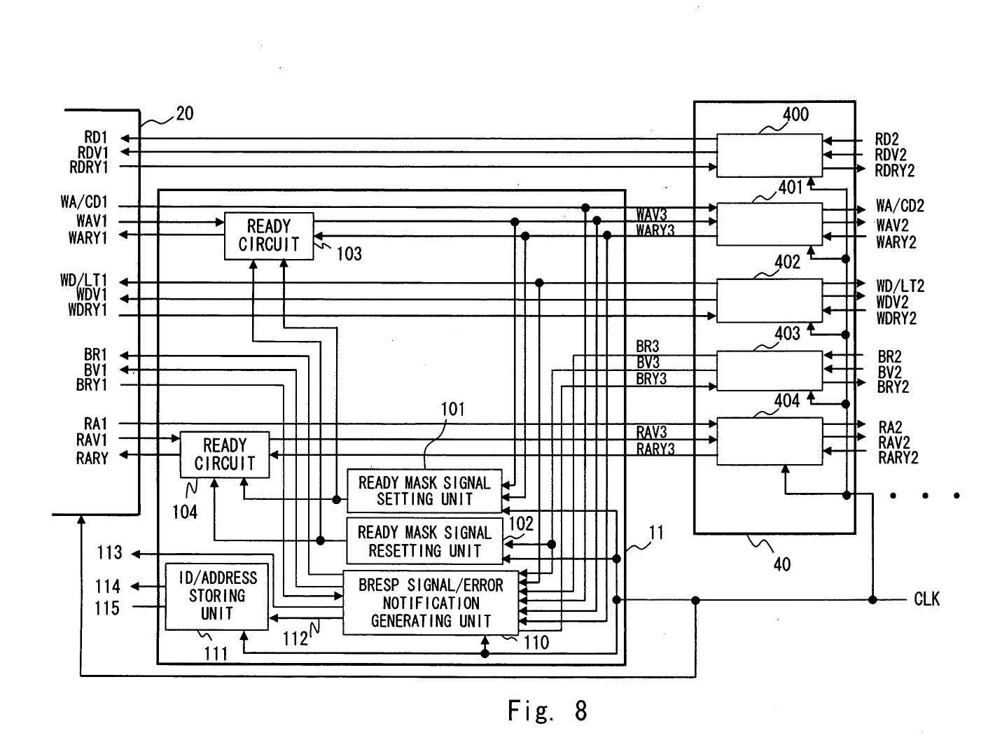

Next, a configuration of the write response control unit 11 in accordance with the second exemplary embodiment of the present invention is explained with reference to FIG. 8. FIG. 8 is a configuration diagram of the write response control unit 11 according to the second exemplary embodiment of the present invention.

The write response control unit 11 in accordance with the second exemplary embodiment differs from the write response control unit 10 in accordance with first exemplary embodiment in the following points. That is, the write response control unit 11 includes a bresp signal/error notification generating unit 110 in place of the signal generating unit 100. Furthermore, the write response control unit 11 further includes an ID/address string unit 111. Note that the description of the composition elements 101-104 similar to those of the first exemplary embodiment is omitted.

The bresp signal/error notification generating unit 110 includes a function of the signal generating unit 100. The bresp signal/error notification generating unit 110 outputs the dummy write response signal to the bus master 20, when the bresp signal/error notification generating unit 110 detects the end of the write data signal WD/LT1 output from the bus master 20. Furthermore, when the authentic write response signal indicates an error, the bresp signal/error notification generating unit 110 notifies that effect to the CPU 60.

The ID/address storing unit 111 stores data included in the write address signal WA/CD1, when the handshake for the write access is complete. Further, the ID/address storing unit 111 outputs the stored data to the CPU 60, when the authentic write response signal BR3 indicates the error. For example, the ID/address storing unit 111 includes a storage device such as a memory or a register.

Furthermore, the bresp signal/error notification unit 110 and the ID/address storing unit 111 operate by being supplied with the clock signal CLK.

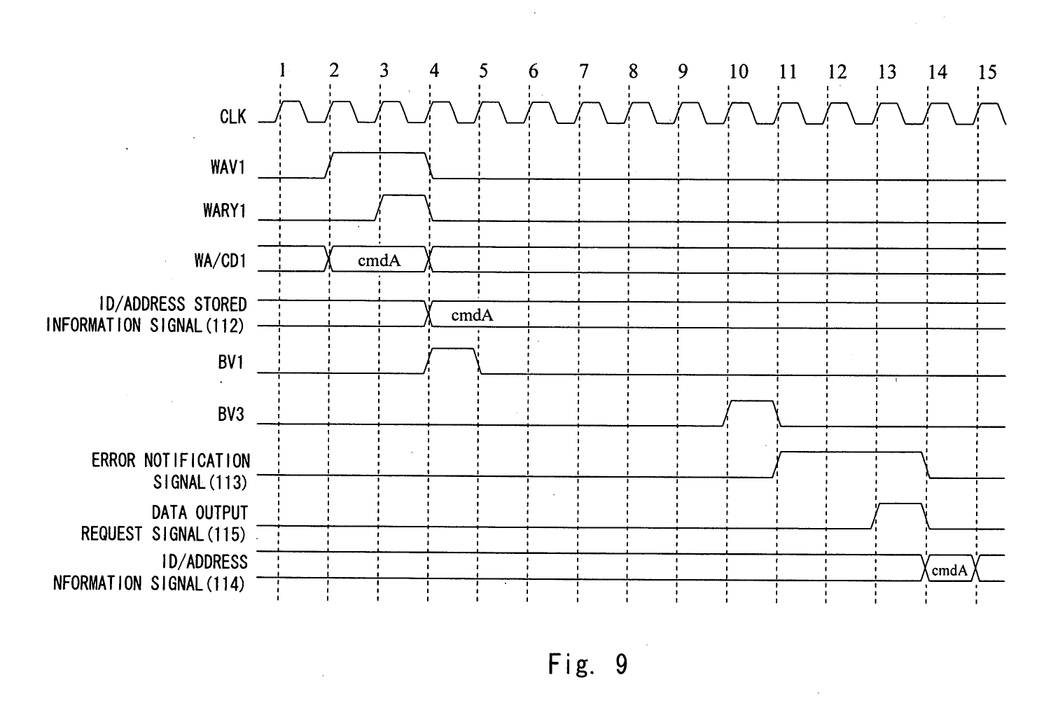

Next, an operation of the bus system 2 according to the second exemplary embodiment of the present invention is explained with reference to FIG. 9. FIG. 9 is an operation timing diagram of the write response control unit 11 according to the second exemplary embodiment of the present invention. Note that FIG. 9 is an operation timing diagram of the write response control unit 11 when the authentic write complete response signal BR3 indicates the error in the case where the operation similar to that shown in FIG. 4 and FIG. 6 of the first exemplary embodiment is performed. The description of the same operation as the first exemplary embodiment is omitted.

When the write address valid signal WAV3 and the write address ready signal WARY3 become valid as “1” at cycle 3, the bresp/error notification generating unit 110 outputs an ID/address stored information signal 112 to the ID/address storing unit 111. The ID/address stored information signal 112 includes ID/address information that is data included in the write address signal WA/CD1. Note that, at cycle 3, the masking is not performed by the ready circuit 103. Thus, values of the write address valid signal WAV3 and the write address ready signal WAR3 are the same as the values of the write address valid signal WAV1 and the write address ready signal WARY1 shown in FIG. 9. More specifically, the ID/address information includes an address at which a data is written, an ID of access that is defined in the AXI bus standard, and so on.

At cycle 4, the ID/address storing unit 111 stores the ID/address information included in the ID/address stored information signal 112 input from the bresp/error notification generating unit 110.

At cycle 10, the bresp/error notification unit 110 receives the authentic write complete response signal BR3 and the write complete response valid signal BV3 that are output from the sub register slice 403. When the bus slaves 30-32 detect an error in which data cannot be written, the bus slaves 30-32 store error information indicating the error in the write complete response signal and output the write complete response signal. For example, when the sub master 20 specifies an address that the bus slaves 30-32 cannot access in the write address signal WA/CD1, the bus slaves 30-32 detect the error.

When the write complete response signal BR3 input from the sub register slice 403 includes the error information at cycle 10, the bresp/error notification generating unit 110 outputs the error notification signal 113 to the CPU 60 at cycle 11. This enables the CPU 60 to detect the occurrence of an error.

When the CPU 60 receives the error notification signal 113, the CPU 60 outputs the data output request signal 115 to the ID/address storing unit 111 at cycle 13.

When the ID/address storing unit 111 receives the data output request signal 115, at cycle 14, the ID/address storing unit 111 outputs the ID/address information 114 including the ID/address information stored at cycle 4.

This enables the CPU 60 to obtain the ID/address information when the error is detected. Consequently, the cause of the error can be easily analyzed based on the ID/address information on the write access in which the has error occurred.

As explained above, in this second exemplary embodiment, when the authentic write complete response signal BR3 indicates that the error has been detected, information indicating that effect is output to an external resource such as the CPU 60. Thus, it is possible to perform processing by accurately recognizing the error of the write access, and perform processing.

Furthermore, in this second exemplary embodiment, when the handshake for stating the write access is complete, the data included in the write address signal WA/CD1, which is validly transmitted from the bus master 20 to the register slice 40, is stored. Then, when an error in the write access is detected, an external resource such as the CPU 60 obtains the stored data. Thus, it is possible to obtain the information on the write access in which the error has occurred.

The present invention is not limited to the above exemplary embodiments, but can be modified as appropriate within the scope of the present invention. For example, in these exemplary embodiments, the case that the number of stages of the register slice is three is exemplified, but the number of the stages of the register slice is not limited to this.

The first and second exemplary embodiments can be combined as desirable by one of ordinary skill in the art.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A bus system comprising:
a bus master that performs a preparation for a next access after receiving a write response signal indicating a write result of data in a write access;
a bus slave that writes data indicated by a write data signal according to an output of the write data signal from the bus master in the write access, and outputs an authentic write response signal in the writing to the bus master;
a bus that connects the bus master and the bus slave, and includes a register slice; and
a signal generating unit that outputs a dummy write response signal to the bus master when an end of the write data signal output from the bus master is detected.

2. The bus system according to claim 1, wherein
the signal generating unit masks the authentic write response signal output from the bus slave.

3. The bus system according to claim 2, wherein the authentic write response signal includes a write complete response signal indicating a write result of the data, and a write complete response valid signal indicating an existence of the write complete response signal, and
the signal generating unit masks the write complete response valid signal.

4. The bus system according to claim 1, further comprising a handshake control unit that inhibits a handshake for starting the next access until the authentic write response signal is output from the bus slave after the handshake for starting the write access is complete.

5. The bus system according to claim 4, wherein
the authentic write response signal includes a write complete response signal indicating a write result of the data, and a write complete response valid signal indicating an existence of the write complete response signal, and
the handshake control unit evaluates whether the authentic write response signal is output from the bus slave, based on the write complete response valid signal.

6. The bus system according to claim 4, further comprising a CPU,
wherein when the authentic write response signal indicates an error, the signal generating unit notifies that effect.

7. The bus system according to claim 6, further comprising a storage unit, wherein the signal generating unit stores data in the storage unit, when the handshake for starting the write access is complete, the data being included in a signal validly transmitted from the bus master, and,
the CPU obtains the data stored in the storage unit, when the CPU is notified from the signal generating unit that the authentic write response signal indicates the error.

8. The bus system according to claim 4, wherein
the bus master outputs a write address signal indicating an address at which the data indicated by the write data signal is written in the write access, and outputs a write address valid signal indicating an existence of the write address signal to the register slice,
the register slice outputs a write address ready signal indicating whether the write address signal can be obtained to the bus master, and
the handshake control unit evaluates whether the handshake for starting the write access is complete based on the write address valid signal and the write address ready signal.

9. The bus system according to claim 8, wherein the handshake control unit inhibits the handshake for starting the next access by masking the write address valid signal and the write address ready signal.

10. The bus system according to claim 4, wherein the signal generating unit and the handshake control unit are connected between the bus master and the register slice by the bus.

11. The bus system according to claim 1, wherein the bus is an AXI (Advanced eXtensible Interface) bus.

12. A bus control method for a bus that connects a bus master and a bus slave, and includes a register slice, the bus master being configured to perform a preparation for a next access after receiving a write response signal indicating a write result of data in a write access, the bus slave being configured to write data indicated by a write data signal according to an output of the write data signal from the bus master in the write access, and to output an authentic write response signal in the writing to the bus master, the bus control method comprising:
detecting an end of the write data signal output from the bus master; and
outputting a dummy write response signal to the bus master.
